(19) United States
(12) Patent Application Publication
(10) Pub. No.: US 2024/0169261 A1
(43) Pub. Date: May 23, 2024

(54) METHOD AND DEVICE FOR DOMAIN GENERALIZED INCREMENTAL LEARNING UNDER COVARIATE SHIFT

(71) Applicant: LG ELECTRONICS INC., Seoul (KR)

(72) Inventors: Hyoeun KIM, Seoul (KR); Kamin LEE, Seoul (KR); Yeonjee JUNG, Seoul (KR); Hyejeong JEON, Seoul (KR); Arin MINASIAN, Seoul (KR)

(73) Assignee: LG ELECTRONICS INC., Seoul (KR)

(21) Appl. No.: 18/207,520

(22) Filed: Jun. 8, 2023

Related U.S. Application Data
(60) Provisional application No. 63/424,459, filed on Nov. 10, 2022.

(51) Int. Cl. G06N 20/00

(52) U.S. Cl. CPC G06N 20/00

(57) ABSTRACT

A computer-implemented method includes obtaining a labeled data set of images including data from a rehearsal memory and new input data, augmenting the labeled data set to generate a first data set and a second data set, wherein each image of the first data set corresponds to a corresponding image of the second data set, inputting the first data set into a query encoder and inputting the second data set into a momentum encoder to obtain encodings output by the query encoder and the momentum encoder, obtaining a contrastive loss based on the encodings using a sum of a first contrastive loss function and a second contrastive loss function, updating parameters of the query encoder based on the obtained contrastive loss, and updating parameters of the momentum encoder based on parameters of the query encoder.

### CROSS-REFERENCE TO RELATED APPLICATION

Pursuant to 35 U.S.C. § 119(e), this application claims the benefit of U.S. Provisional Patent Application No. 63/424,459, filed on Nov. 10, 2022, the contents of which are hereby incorporated by reference herein in its entirety.

### FIELD

The present disclosure generally relates to improvements in class incremental learning under domain shift in deep-learning based image classifiers.

### BACKGROUND

Machine learning is an area of artificial intelligence that includes a field of study that gives computers the capability to learn without being explicitly programmed. Specifically, machine learning is a technology used for researching and constructing a system for learning, predicting, and improving its own performance based on empirical data and an algorithm for the same. The machine learning algorithms construct a specific model in order to obtain the prediction or the determination based on the input data, rather than performing strictly defined static program instructions.

Machine learning image classifiers are algorithms that use computer vision techniques and artificial intelligence to identify and categorize images based on their features and patterns. These algorithms are trained on a large dataset of labeled images to learn the patterns that distinguish different objects and categorize them. During the training process, the classifier uses machine learning algorithms such as decision trees, support vector machines, or deep neural networks to learn how to identify specific objects based on the features and patterns present in the images. Once the classifier has been trained, it can then be used to classify new images. Image classifiers are commonly used in a variety of applications, such as image recognition, object detection, and facial recognition.

Incremental machine learning image classifiers are algorithms that can learn and improve their performance over time as they receive new data and examples. Unlike traditional machine learning algorithms that require all data to be present at the start of the learning process, incremental machine learning algorithms can continuously learn and update their models as they receive new information. This approach is useful in situations where data is generated continuously, or when it is impractical to store all the data at once. An incremental machine learning image classifier can be trained on a small set of images to start with, and as new images are added, the classifier can learn and improve its performance. The classifier can also identify and discard irrelevant or redundant information that could have been previously learned, however, this may also lead to unintended disadvantages.

Domain Generalized Incremental Learning (DGIL) is a technique that addresses the challenge of incremental learning in the presence of domain shift. This approach allows a model to learn new tasks in an incremental manner, without forgetting the previously learned information, even when the new task is drawn from a different distribution (domain) compared to the earlier tasks.

As noted, traditional incremental learning, a model is trained on a sequence of tasks, with the goal of preserving performance on previously learned tasks while learning new ones. However, this can become challenging when the distribution of the data changes between tasks, leading to what is known as “catastrophic forgetting,” as training data sets become tailored to new classifications and distributions without maintaining previously learned data. DGIL was proposed as a solution to this problem, by training models to generalize across domains, so that they can learn new tasks without forgetting previously learned information.

The primary motivation behind DGIL is to develop models that can learn new tasks in an efficient and effective manner, especially in real-world scenarios where the distribution of data changes over time, such as in autonomous driving, robotics, and recommendation systems.

However, such previous efforts in incremental learning focus on only one aspect of the aforementioned forgetting problem, either learning to classify new classes as new data is collected, or trying to adapt to shifts in distribution of the data, i.e., the aforementioned domains.

### SUMMARY

Accordingly, an object of the present disclosure is to address the above challenges with a two-stage approach based on contrastive domain generalization and class incremental learning with rehearsal memory. Embodiments of the present disclosure include solutions to the incremental learning problem for deep-learning based classifiers, including image classifiers. In particular, disclosed are embodiments of a class-incremental learning under covariate shift, in which the label set of the data expands while its underlying distribution changes over time. The disclosed embodiments include domain generalized incremental learning (DGIL) to realize improved performance for deep learning models in a constantly changing deployment environment. By employing domain generalization via contrastive learning and momentum distillation, the disclosed embodiments may maintain performance stability as the distribution of the data shifts between different domains. Plasticity of the model may be achieved through balanced fine-tuning using a rehearsal memory of exemplars, populated throughout the learning time horizon.

Specifically, in the first stage, the embodiments of the disclosure leverages supervised contrastive learning and momentum distillation, coupled with randomized data augmentation to learn domain agnostic features of the data samples during each training task. These features are then fine-tuned in a balanced training stage that uses exemplars from current and previous tasks, available through a rehearsal memory, to achieve a desirable stability-plasticity trade-off in the class incremental learning setting. The disclosed approach has been shown to consistently outperform known existing methods when introducing a class incremental learning scenario into publicly available datasets that are commonly used to study domain adaptation for image classification.

An implementation of the present disclosure includes a computer-implemented method for training a classification model, the computer-implemented method comprising: obtaining a labeled data set of images comprising data from a rehearsal memory and new input data; augmenting the labeled data set to generate a first data set and a second data set, wherein each image of the first data set corresponds to a corresponding image of the second data set; inputting the first data set into a query encoder and inputting the second data set into a momentum encoder to obtain encodings output by the query encoder and the momentum encoder; obtaining a contrastive loss based on the encodings using a sum of a first contrastive loss function and a second contrastive loss function; updating parameters of the query encoder based on the obtained contrastive loss; and updating parameters of the momentum encoder based on parameters of the query encoder.

In some implementations, the computer-implemented method may include updating the rehearsal memory with samples of the new input data.

In some implementations, the rehearsal memory is updated based on a balanced-fine tuning such that a number of samples of data existing in the rehearsal memory from previous tasks is equal to a number of samples of the new input data to be stored in the rehearsal memory.

In some implementations, images of the samples of data existing in the rehearsal memory from previous tasks and images of the samples of the new input data to be stored in the rehearsal memory are both selected randomly.

In some implementations, the the query encoder and the momentum encoder have a same size and configuration.

In some implementations, the first contrastive loss function is configured to identify encodings of different views of a same input image as anchor-positive pairs in a feature space.

In some implementations, the second contrastive loss function is configured to identify encodings of two different sample images from a same class as anchor-positive pairs in the feature space.

In some implementations, parameters of the momentum encoder are updated based on exponentially weighted moving averages of the parameters of the query encoder.

Another implementation of the present disclosure includes a computing device for training a classification model to be provided to an edge device, the computing device comprising: a transceiver; a memory; and one or more processors configured to: obtain a labeled data set of images comprising data from a rehearsal memory stored in the memory and new input data; augment the labeled data set to generate a first data set and a second data set, wherein each image of the first data set corresponds to a corresponding image of the second data set; input the first data set into a query encoder and inputting the second data set into a momentum encoder to obtain encodings output by the query encoder and the momentum encoder; obtain a contrastive loss based on the encodings using a sum of a first contrastive loss function and a second contrastive loss function; update parameters of the query encoder based on the obtained contrastive loss; update parameters of the momentum encoder based on parameters of the query encoder; and provide the classification model including parameters of the query encoder to the edge device via the transceiver.

Yet another implementation of the present disclosure includes a non-transitory memory storing one or more programs, which, when executed by the one or more processors of a computing device, cause the computing device to perform: obtaining a labeled data set of images comprising data from a rehearsal memory and new input data; augmenting the labeled data set to generate a first data set and a second data set, wherein each image of the first data set corresponds to a corresponding image of the second data set; inputting the first data set into a query encoder and inputting the second data set into a momentum encoder to obtain encodings output by the query encoder and the momentum encoder; obtaining a contrastive loss based on the encodings using a sum of a first contrastive loss function and a second contrastive loss function; updating parameters of the query encoder based on the obtained contrastive loss; and updating parameters of the momentum encoder based on parameters of the query encoder.

In accordance with some implementations, a computing or electronic device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of an electronic device, cause the electronic device to perform or cause performance of any of the methods described herein. In accordance with some implementations, an electronic device includes: one or more processors, a non-transitory memory, and means for performing or causing performance of any of the methods described herein.

The present disclosure is not limited to what has been described above, and other aspects and advantages of the present disclosure not mentioned above will be understood through the following description of implementations of the present disclosure. Further, it will be understood that the aspects and advantages of the present disclosure may be achieved by the configurations described in claims and combinations thereof.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a view illustrating an example of an AI system comprising an AI device, an AI server, and a network connecting the above-mentioned components in accordance with some implementations.

FIG. 2 is a view illustrating a configuration of an edge device including an object identifying apparatus in accordance with some implementations.

FIG. 3 is a block diagram of an example neural network in accordance with some implementations.

FIGS. 4A, 4B, 4C illustrate various learning scenarios under class-only, domain-only, or covariate data shift.

FIG. 5 is a diagram showing various aspects of contrastive domain generalization according to embodiments of the present disclosure.

FIG. 6 is a flowchart showing a method implementing contrastive domain generalization and class incremental learning with rehearsal memory according to an embodiment of the present disclosure.

FIG. 7 is a diagram showing various aspects of balanced fine-tuning performed between tasks according to an embodiment of the present disclosure.

FIGS. 8A-C depict performance changes compared between embodiments of the present disclosure and the existing art across task progressions as performed on the Office-31 dataset.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Hereinafter, the implementations disclosed in the present specification will be described in detail with reference to the accompanying drawings, the same or similar elements regardless of a reference numeral are denoted by the same reference numeral, and a duplicate description thereof will be omitted. In the following description, the terms “module” and “unit” for referring to elements are assigned and used interchangeably in consideration of convenience of explanation, and thus, the terms per se do not necessarily have different meanings or functions. Wherever possible, the same reference numbers will be used throughout the drawings to refer to the same or like parts. In the following description, known functions or structures, which may confuse the substance of the present disclosure, are not explained. The accompanying drawings are used to help easily explain various technical features, and it should be understood that the implementations presented herein are not limited by the accompanying drawings. As such, the present disclosure should be construed to extend to any alterations, equivalents, and substitutes in addition to those which are particularly set out in the accompanying drawings.

The terminology used herein is used for the purpose of describing particular example implementations only and is not intended to be limiting. As used herein, the singular forms “a,” “an,” and “the” may be intended to include the plural forms as well, unless the context clearly indicates otherwise. The terms “comprises,” “comprising,” “includes,” “including,” “containing,” “has,” “having” or other variations thereof are inclusive and therefore specify the presence of stated features, integers, steps, operations, elements, and/or components, but do not preclude the presence or addition of one or more other features, integers, steps, operations, elements, components, and/or groups thereof. Furthermore, these terms such as “first,” “second,” and other numerical terms, are used only to distinguish one element from another element. These terms are generally only used to distinguish one element from another.

Hereinafter, implementations of the present disclosure will be described in detail with reference to the accompanying drawings. Like reference numerals designate like elements throughout the specification, and overlapping descriptions of the elements will not be provided.

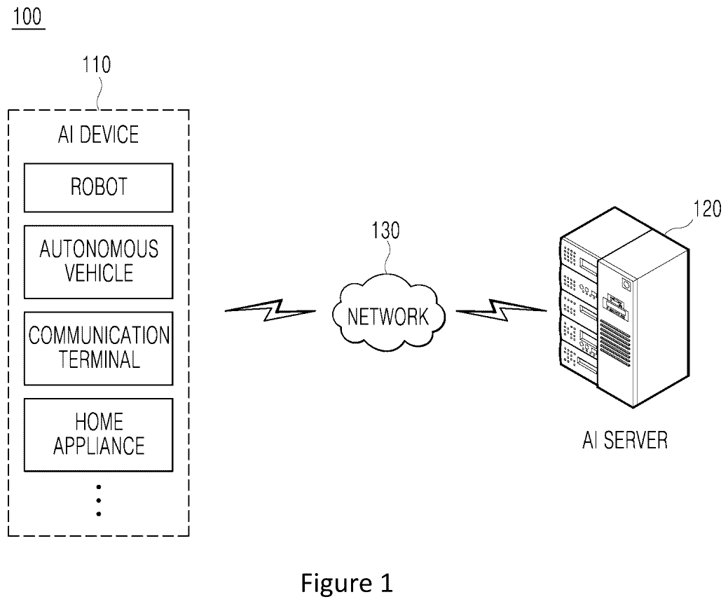

FIG. 1 is a view illustrating an example of an AI system including an AI device, an AI server, and a network connecting the above-mentioned components. While pertinent features are shown, those of ordinary skill in the art will appreciate from the present disclosure that various other features have not been illustrated for the sake of brevity and so as not to obscure more pertinent aspects of the example implementations disclosed herein.

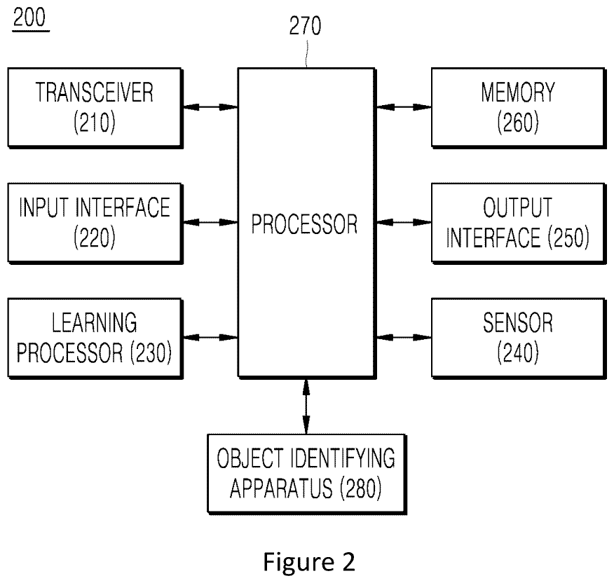

Referring to FIG. 1, the AI device 100 may include an artificial intelligence based object identifying apparatus of the present disclosure and for example, include at least one of a robot, an autonomous vehicle, a communication terminal (for example, a mobile phone, a smart phone, or a tablet PC), an edge device (not shown in FIG. 1) (e.g., the edge device 200 shown in FIG. 2), and a home appliance (for example, a robot cleaner).

Here, artificial intelligence refers to a field of studying artificial intelligence or a methodology to create the artificial intelligence and machine learning refers to a field of defining various problems treated in the artificial intelligence field and studying a methodology to solve the problems. In addition, machine learning may be defined as an algorithm for improving performance with respect to a task through repeated experience with respect to the task.

An artificial neural network (ANN) is a model used in machine learning, and may refer in general to a model with problem-solving abilities, composed of artificial neurons (nodes) forming a network by a connection of synapses. The ANN may be defined by a connection pattern between neurons on different layers, a learning process for updating model parameters, and an activation function for generating an output value.

The ANN may include an input layer, an output layer, and may selectively include one or more hidden layers. Each layer includes one or more neurons, and the ANN may include synapses that connect the neurons to one another. In an ANN, each neuron may output a function value of an activation function with respect to the input signals inputted through a synapse, weight, and bias.

A model parameter refers to a parameter determined through learning, and may include weight of synapse connection, bias of a neuron, and the like. Moreover, hyperparameters refer to parameters which are set before learning in a machine learning algorithm, and include a learning rate, a number of iterations, a mini-batch size, an initialization function, and the like.

The objective of training an ANN is to determine a model parameter for significantly reducing a loss function. The loss function may be used as an indicator for determining an optimal model parameter in a learning process of an artificial neural network.

The machine learning may train an artificial neural network by supervised learning.

Supervised learning may refer to a method for training an artificial neural network with training data that has been given a label. In addition, the label may refer to a target answer (or a result value) to be guessed by the artificial neural network when the training data is inputted to the artificial neural network.

As a result, the artificial intelligence based object identifying apparatus may train the artificial neural network using a machine learning algorithm using methods such as incremental learning or requests a trained artificial neural network from the AI server 120 to receive the trained artificial neural network from the AI server 120. Further, when the image is received, the object identifying apparatus may estimate a type of the object in the received image using the trained artificial neural network.

When the AI server 120 receives the request for the trained artificial neural network from the AI device 110, the AI server 120 may train the artificial neural network using the machine learning algorithm and provide the trained artificial neural network to the AI device 110. The AI server 120 may be composed of a plurality of servers to perform distributed processing. In this case, the AI server 120 may be included as a configuration of a portion of the AI device 110, and may thus perform at least a portion of the AI processing together.

The network 130 may connect the AI device 110 and the AI server 120. The network 130 may include a wired network such as a local area network (LAN), a wide area network (WAN), a metropolitan area network (MAN), or an integrated service digital network (ISDN), and a wireless network such as a wireless LAN, a CDMA, Bluetooth®, or satellite communication, but the present disclosure is not limited to these examples. The network 130 may also send and receive information using short distance communication and/or long distance communication. The short-range communication may include Bluetooth®, radio frequency identification (RFID), infrared data association (IrDA), ultra-wideband (UWB), ZigBee, and Wi-Fi (wireless fidelity) technologies, and the long-range communication may include code division multiple access (CDMA), frequency division multiple access (FDMA), time division multiple access (TDMA), orthogonal frequency division multiple access (OFDMA), and single carrier frequency division multiple access (SC-FDMA).

The network 130 may include connection of network elements such as a hub, a bridge, a router, a switch, and a gateway. The network 130 can include one or more connected networks, for example, a multi-network environment, including a public network such as an internet and a private network such as a safe corporate private network. Access to the network 130 may be provided through one or more wire-based or wireless access networks. Furthermore, the network 130 may support the Internet of Things (IoT) network for exchanging and processing information between distributed elements such as things, 3G, 4G, Long Term Evolution (LTE), 5G communications, or the like.

FIG. 2 is a view illustrating a configuration of an edge device including an object identifying apparatus according to an implementation of the present disclosure.

Referring to FIG. 2, the AI device (e.g., the AI device 110 shown in FIG. 1) or the edge device 200 includes a transceiver 210, an input interface 220, a learning processor 230, a sensor 240, an output interface 250, a memory 260, a processor 270, and an object identifying apparatus 280.

The transceiver 210 may transmit or receive data to/from external devices such as other AI device or AI server using wireless/wired communication techniques. For example, the transceiver 210 may transmit or receive sensor data, user input, a learning model, a control signal, and the like with the external devices.

In this case, the communications technology used by the transceiver 210 may be technology such as global system for mobile communication (GSM), code division multi access (CDMA), long term evolution (LTE), 5G, wireless LAN (WLAN), Wi-Fi, Bluetooth™, radio frequency identification (RFID), infrared data association (IrDA), ZigBee, and near field communication (NFC).

The input interface 220 may obtain various types of data. The input interface 220 may include a camera for inputting an image signal, a microphone for receiving an audio signal, and a user input interface for receiving information inputted from a user. Here, the camera or the microphone is treated as a sensor so that a signal obtained from the camera or the microphone may also be referred to as sensing data or sensor information.

The input interface 220 may obtain, for example, learning data for model learning and input data used when output is obtained using a learning model. The input interface 220 may obtain raw input data. In this case, the processor 270 or the learning processor 230 may extract an input feature by preprocessing the input data.

The learning processor 230 may allow a model, composed of an artificial neural network to be trained using learning data. Here, the trained artificial neural network may be referred to as a trained model. The trained model may be used to infer a result value with respect to new input data rather than learning data, and the inferred value may be used as a basis for a determination to perform an operation of classifying the detected hand motion. The learning processor 230 may perform AI processing together with a learning processor of the AI server (e.g., the AI server 120 shown in FIG. 1).

Further, the learning processor 230 may include a memory which is integrated or implemented in the edge device 200, but is not limited thereto and may be implemented using an external memory directly coupled to the edge device or a memory sustained in the external device.

The sensor 240 may obtain at least one of internal information of the edge device 200, surrounding environment information of the edge device 200, or user information by using various sensors. The sensor 240 may include a proximity sensor, an illumination sensor, an acceleration sensor, a magnetic sensor, a gyroscope sensor, an inertial sensor, an RGB sensor, an infrared (IR) sensor, a finger scan sensor, an ultrasonic sensor, an optical sensor, a microphone, a light detection and ranging (LiDAR) sensor, radar, or a combination thereof

The output interface 250 may generate a visual, auditory, or tactile related output. The output interface 250 may include a display outputting visual information, a speaker outputting auditory information, and a haptic module outputting tactile information.

The memory 260 may store data supporting various functions of the edge device 200. For example, the memory 260 may store input data, the learning data, the learning model, learning history, or the like, obtained from the input interface 220.

The memory 260 may serve to temporarily or permanently store data processed by the processor 270. Here, the memory 260 may include magnetic storage media or flash storage media, but the scope of the present disclosure is not limited thereto. The memory 260 as described above may include magnetic storage media or flash storage media, but the scope of the present disclosure is not limited thereto. The memory 260 may include an internal memory and/or an external memory and may include a volatile memory such as a DRAM, a SRAM or a SDRAM, and a non-volatile memory such as one time programmable ROM (OTPROM), a PROM, an EPROM, an EEPROM, a mask ROM, a flash ROM, a NAND flash memory or a NOR flash memory, a flash drive such as an SSD, a compact flash (CF) card, an SD card, a Micro-SD card, a Mini-SD card, an XD card or memory stick, or a storage device such as a HDD.

The processor 270 may determine at least one executable operation of the edge device 200 based on information determined or generated by using a data analysis algorithm or a machine learning algorithm. In addition, the processor 270 may control components of the edge device 200 to perform the determined operation.

To this end, the processor 270 may request, retrieve, receive, or use data of the learning processor 230 or the memory 260, and may control components of the edge device 200 to execute a predicted operation or an operation determined to be preferable of the at least one executable operation.

In this case, when it is required to be linked with the external device to perform the determined operation, the processor 270 may generate a control signal for controlling the external device and transmit the generated control signal to the corresponding external device.

The processor 270 obtains intent information about user input, and may determine a requirement of a user based on the obtained intent information. The processor 270 may obtain intent information corresponding to user input by using at least one of a speech to text (STT) engine for converting voice input into a character string or a natural language processing (NLP) engine for obtaining intent information of a natural language.

In an implementation, the at least one of the STT engine or the NLP engine may be composed of artificial neural networks, some of which are trained according to a machine learning algorithm. In addition, the at least one of the STT engine or the NLP engine may be trained by the learning processor 230, trained by a learning processor of an AI server, or trained by distributed processing thereof.

The processor 270 collects history information including, for example, operation contents and user feedback on an operation of the edge device 200, and stores the history information in the memory 260 or the learning processor 230, or transmits the history information to an external device such as an AI server (e.g., the AI server shown in FIG. 1). The collected history information may be used to update a learning model.

The processor 270 may control at least some of components of the edge device 200 to drive an application stored in the memory 260. Furthermore, the processor 270 may operate two or more components included in the edge device 200 in combination with each other to drive the application.

The object identifying apparatus 280 may include a receiver, a learner, a memory with a low capacity, an image modifier, and an object determinator. Here, the receiver may be included in the input interface 220, the learner may be included in the learning processor 230, and the memory with a low capacity may be included in the memory 260.

Moreover, FIG. 2 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

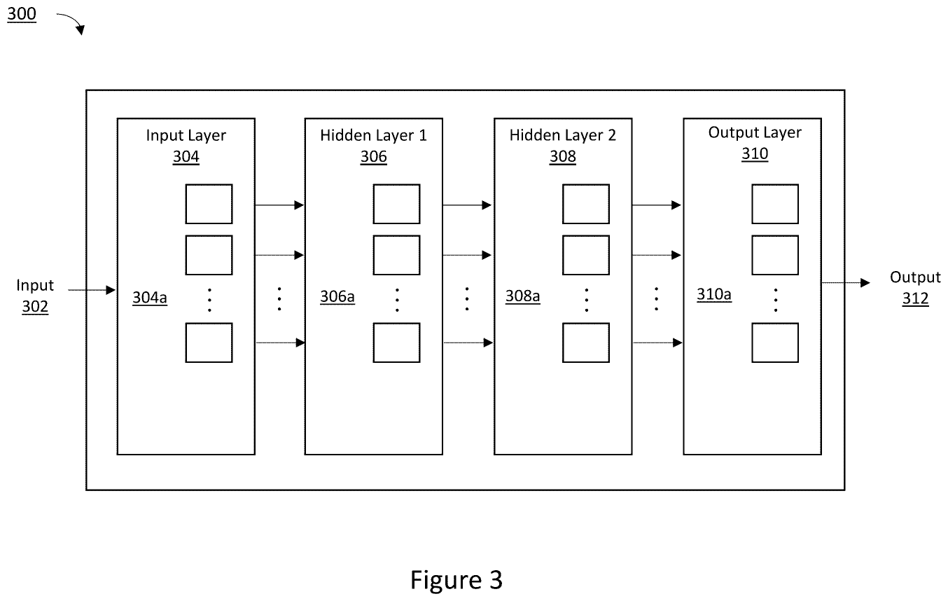

FIG. 3 is a block diagram of an example neural network 300 according to some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations, the neural network 300 includes an input layer 302, a first hidden layer 306, a second hidden layer 308, and an output layer 310. While the neural network 300 includes two hidden layers as an example, those of ordinary skill in the art will appreciate from the present disclosure that one or more additional hidden layers are also present in various implementations. Adding additional hidden layers adds to the computational complexity and memory demands but may improve performance for some applications.

In various implementations, the input layer 304 is coupled (e.g., configured) to receive various inputs 302 (e.g., image data). For example, the input layer 304 receives pixel data from one or more image sensors (e.g., the sensor 240 shown in FIG. 2). In various implementations, the input layer 304 includes a number of long short-term memory (LSTM) logic units 304a, which are also referred to as model(s) of neurons by those of ordinary skill in the art. In some such implementations, an input matrix from the features to the LSTM logic units 304a include rectangular matrices. For example, the size of this matrix is a function of the number of features included in the feature stream.

In some implementations, the first hidden layer 306 includes a number of LSTM logic units 306a. In some implementations, the number of LSTM logic units 306a ranges between approximately 10-500. Those of ordinary skill in the art will appreciate that, in such implementations, the number of LSTM logic units per layer is orders of magnitude smaller than previously known approaches (being of the order of O(101) to O(102)), which allows such implementations to be embedded in highly resource-constrained devices. As illustrated in the example of FIG. 3, the first hidden layer 306 receives its inputs from the input layer 304. For example, the first hidden layer 306 performs one or more of following: a convolutional operation, a nonlinearity operation, a normalization operation, a pooling operation, or the like.

In some implementations, the second hidden layer 308 includes a number of LSTM logic units 308a. In some implementations, the number of LSTM logic units 308a is the same as or similar to the number of LSTM logic units 304a in the input layer 304 or the number of LSTM logic units 306a in the first hidden layer 306. As illustrated in the example of FIG. 3, the second hidden layer 308 receives its inputs from the first hidden layer 306. Additionally, and/or alternatively, in some implementations, the second hidden layer 308 receives its inputs from the input layer 306. For example, the second hidden layer 308 performs one or more of following: a convolutional operation, a nonlinearity operation, a normalization operation, a pooling operation, and/or the like.

In some implementations, the output layer 310 includes a number of LSTM logic units 310a. In some implementations, the number of LSTM logic units 310a is the same as or similar to the number of LSTM logic units 304a in the input layer 304, the number of LSTM logic units 306a in the first hidden layer 306, or the number of LSTM logic units 308a in the second hidden layer 308. In some implementations, the output layer 310 is a task-dependent layer that performs a computer vision related task such as feature extraction, object recognition, object detection, pose estimation, or the like. In some implementations, the output layer 2026 includes an implementation of a multinomial logistic function (e.g., a soft-max function) that produces a number of outputs 312.

Neural networks, such as CNNs are often used to solve computer vision problems including feature extraction, object recognition, object detection, and pose estimation. A modem CNN is typically described as having an input layer, a number of hidden layers, and an output layer. In at least some scenarios, the input to the input layer of the CNN is an image frame while the output layer is a task-dependent layer. The hidden layers often include one of a plurality of operations such as convolutional, nonlinearity, normalization, and pooling operations. For example, a respective convolutional layer may include a set of filters whose weights are learned directly from data. Continuing with this example, the output of these filters are one or more feature maps that are obtained by applying filters to the input data of the convolutional layer.

Incremental learning in machine learning is defined in the context of processing continuous streams of data, i.e., scenarios where is unfeasible to adopt large memories, and operate multiple scans of the data for an update. Various examples of existing attempts to address incremental learning are model-growth approaches which enlarge models architecture and layers size to accommodate for new knowledge; fixed-representation approaches which rely on a rich backbone while altering the model's head; and finetuning adapt gradually model's backbone and head.

These existing methods try to address the limited capability of neural networks to support incremental changes. Incremental learning methods typically rely on knowledge distillation, a technique that decomposes the training loss function into two terms: a distillation term quantifying the (old) knowledge acquired, and a classification term quantifying the (new) knowledge to add.

Furthermore, in traditional approaches memory plays a key role since training requires multiple passes on the input data and rehearsal mechanisms, i.e., re-proposing samples from a previous training set when updating the model, are important to overcome catastrophic forgetting. Existing approaches have typically provided that data from all tasks are simultaneously available during training, thus by interleaving data from multiple tasks during learning forgetting may be minimized because the weights of the network can be concurrently optimized for performance on all or most tasks. However, this approach is not realistic as it requires unlimited memory resources as the continual learning progresses.

In the case of a classification task in which the number of classes increases as the task progresses, the performance of the old classes is rapidly degraded, so there are various existing works on how to overcome this forgetting problem. However, the majority of previous efforts in incremental learning focus on only one aspect of the aforementioned problem, either learning to classify new classes as new data is collected, or trying to adapt to shifts in distribution of the data with the passing of time.

As a real world example, assume a beverage classifier based on images of beverage containers captured by one or more cameras. After training the classifier to classify a given number of beverages (e.g., COCA-COLA, SPRITE, PEPSI, etc.), additional beverage brands (classes, e.g., DR. PEPPER, 7-UP) needing identification are inevitably introduced to the market. Additionally, the distribution of images handled by the classifier may also need to be expanded to process various types of images (domain) input to the classifier, for example images captured by mobile phone cameras, cameras installed in refrigerators, webcam video images, and the like. Therefore, it is necessary to consider that the distribution of various domains and classes may continuously change with newly imported data, requiring training of the classifier to continuously incrementally learn while avoiding forgetting. For these reasons, there are many studies on incremental learning techniques aiming to minimize forgetting of the previous model by using incremental data with limited memory resources and to optimize performance given new data distributions. However, the existing approaches address either domain incremental learning or class incremental learning, without successful solutions for simultaneous class incremental and domain incremental learning.

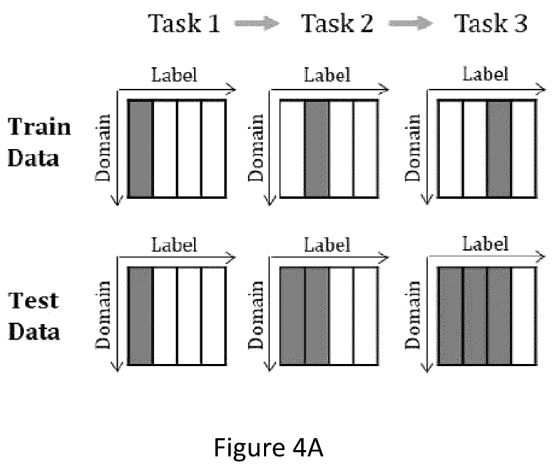

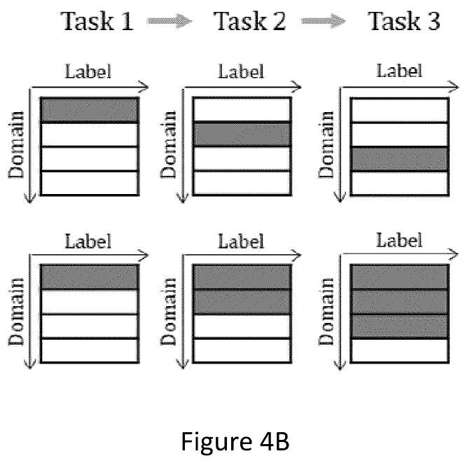

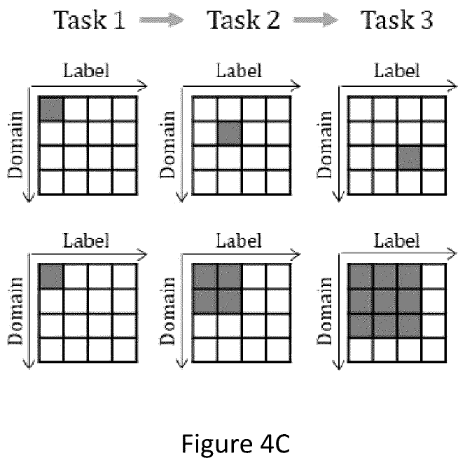

FIGS. 4A-4C illustrate the above described problem formulation in comparison to class-only or domain-only incremental scenarios. The below three scenarios for incremental learning may be represented as an incremental learning setup with T tasks. During the t-th task tÅ{1, 2, . . . , T}, the incoming data is given as [symbol] ₜ={(xₜⁱ, yₜⁱ)}ᵢ₌₁^{N}^{ₜ} where xₜⁱ∈X and yₜⁱ∈ [symbol] ₜ⊆ [symbol] denote the i-th image and corresponding label, respectively. Furthermore, [symbol] ₜ is the set of incoming classes during the t-th task and X and [symbol] denote the global sets of images and labels, respectively. pₜ is defined on X× [symbol] as the joint distribution of images and labels in [symbol] ₜ. The label space of all observed classes up to the t-th task is defined as [symbol] ₜ=Uᵢ₌₁^{t} [symbol] t.

In the existing art, one of the approaches to minimize forgetting in incremental tasks such as those discussed above is knowledge distillation. Knowledge distillation is a technique in machine learning that involves training a smaller model (student model) to mimic the behavior of a larger, more complex model (teacher model). The goal of knowledge distillation is to transfer the knowledge and expertise of the teacher model to the student model, with the aim of achieving comparable or improved performance on a given task. This involves pretraining the teacher model which is typically, in existing approaches, a larger and more complex model than the student model, trained on a large dataset with extensive computational resources to learn powerful representations; and then training the student model which is trained to predict the output of the teacher model on a given dataset.

However, the above techniques of knowledge distillation may lead to overfitting of the student model, especially when the teacher model is much larger and more complex than the student model. Other techniques attempting to mitigate forgetting involve expanding the parameters of the encoder, however this runs into obvious resource and memory limitations. Momentum knowledge distillation has been used to address this problem by introducing a momentum term during training. Instead of directly matching the outputs of the teacher and student models, the student model learns to update its weights in a way that gradually moves it towards the teacher model's predictions over time, using a momentum parameter to control the rate of convergence. This momentum-based approach helps the student model to learn more robust representations from the teacher model, without overfitting to the specific examples in the training dataset. However, the existing implementations of momentum-based approach are insufficient to solve all of the shortcomings which are addressed by the present disclosure.

FIG. 4A represents the problem posed by class incremental learning, or “new class” (NC), where the label space is disjointed between samples from different tasks, but consists of identical sets of domains. In other words, the data available at each task only contains samples from a new label set and samples from previously seen classes are not present anymore. A worst case scenario is presented with regards to the class-incremental learning where [symbol] ₜ∩\tilde{C}ₜ₋₁=Ø. In the above beverage classifier example, this corresponds to the introduction of new brands of beverages with each training/test data, while the newly input images are all still captured by a mobile phone camera across the data. This may be referred to as class incremental learning, where [symbol] ₜ∩ [symbol] _{t\hat{ }′}=Ø and pₜ=p_{t\hat{ }′}.

FIG. 4B represents the problem posed by domain incremental learning, or “new domain” (ND), where the domain of data is shifted between different tasks, but the label spaces remain aligned. In other words, the underlying distribution of the images from each task is different than those in the other tasks. In the above beverage classifier example, this corresponds to the brands of beverages being maintained across the new data, while new types of images of the beverages are introduced, for example, the introduction of additional camera types, video frames, grayscale images, and the like. This may be referred to as domain incremental learning, where [symbol] ₜ\ [symbol] _{t\hat{ }′}=Ø and pₜ≠p_{t\hat{ }′}.

FIG. 4C represents the problem addressed by this disclosure, and which has not been sufficiently addressed by the existing art, where both the domain and the class shift between data from different tasks, or “new class and domain” (NCD). Thus, a set of labels for every session is unique, and the distribution of training data for every session is unique. In the above beverage classifier example, this corresponds to the introduction of new brands of beverages with each training/test data, while new types of images of the beverages are introduced, for example, additional camera types, video frames, and the like. This may be referred to as class/domain or class and domain incremental learning, where [symbol] ₜ∩ [symbol] _{t\hat{ }′}=Ø and pₜ≠p_{t\hat{ }′}.

To address the above problems, embodiments of the present disclosure include a two-stage training pipeline, including a first stage in which contrastive learning is used to learn a domain-agnostic representation of the input images, and a second stage in which a balanced memory of previous and newly arrived classes is utilized to fine-tune the classifier to achieve a desirable stability-plasticity trade-off.

In the first stage, contrastive learning is used to learn a domain-agnostic representation of input images. Contrastive learning, specifically contrastive self-supervised learning, involves learning representations of data by contrasting similar and dissimilar examples, without access to labels. The model learns to map similar examples in the input space to similar representations in the learned feature space and dissimilar examples to different representations. This is achieved by training the model to maximize the similarity between examples that belong to the same class or have some other form of similarity, while minimizing the similarity between examples that belong to different classes or are dissimilar in some other way. Thus, a similarity metric, such as cosine similarity or dot product, is applied to pairs or groups of examples, to determine how similar or dissimilar they are. The model is then trained to minimize the similarity between dissimilar pairs and maximize the similarity between similar pairs.

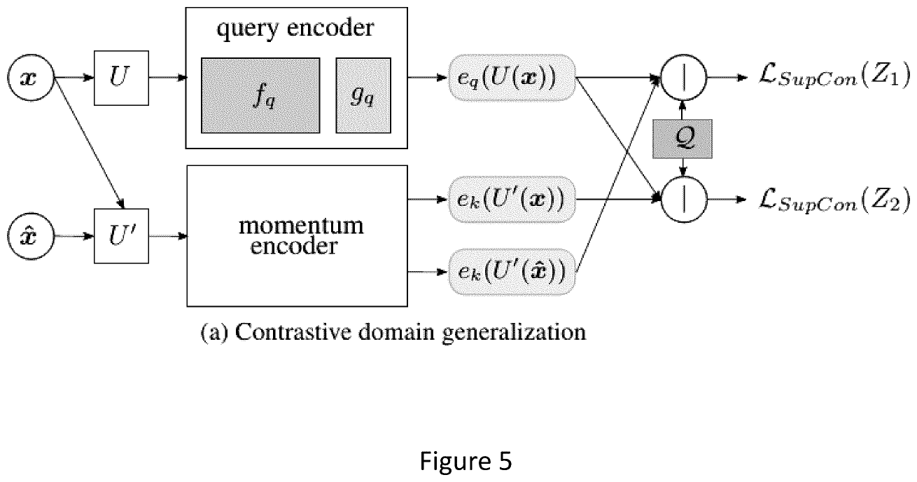

FIG. 5 shows a representation of an embodiment of a technique for domain generalization with contrastive learning of the present disclosure. The first stage of the training pipeline has the following main components: (1) a randomized augmentation function; (2) a query encoder; (3) a momentum encoder; (4) a first-in-first-out (FIFO) queue containing encodings of data samples from previous mini-batches; and (5) a rehearsal memory containing exemplars from previous training tasks.

### Domain Generalization with Contrastive Learning

In (1), a randomized augmentation function T(⋅) is provided which can be sampled to generate several correlated augmented views of input images.

In (2), a query encoder e_{q}(⋅):X→ [symbol] may be provided which generates a dₚ-dimensional numerical projection of its input image. The query encoder itself consists of a base feature extractor f_{q}(⋅):X→ [symbol] coupled with a projection head g_{q}(⋅): [symbol] → [symbol] . The parameters of the query encoder (θ_{q}) are trained using back-propagation.

The projection head is typically a fully-connected layer or a series of layers, e.g., a multi-layer perceptron (MLP) with one or more hidden layers, that learn a nonlinear mapping from the encoded features to a new feature space. The output of the projection head is used as the final embedding or representation of the input data, which can be used for classification or clustering. The projection head is used to maximize the similarity between representations of similar examples and minimize the similarity between representations of dissimilar examples. This is achieved by training the projection head to maximize a contrastive loss function that encourages similar examples to have similar representations and dissimilar examples to have different representations.

The feature extractor is designed to extract relevant features or patterns from raw input data in order to enable more effective learning and generalization. This can be a convolutional neural network (CNN), a transformer, or any other suitable network architecture.

In (3), a momentum encoder eₖ(⋅) with an architecture identical to the query encoder is provided. The parameters of the momentum encoder (θₖ) are updated using the momentum rule, i.e., as an exponentially weighted moving average (EMA) of the parameters of the query encoder, for example by using the following equation:

θₖ=mθₖ+(1−m)θ_{q} Equation 1:

Where m∈[0,1) is a momentum coefficient.

In (4), a first-in-first-out (FIFO) queue containing encodings of data samples from previous mini-batches is provided, denoted herein as Q∈ [symbol] , where Q is the size of the queue. Such queue allows for decoupling the number of feature vectors available for contrastive learning from the mini-batch size. To enable supervised contrastive learning, the corresponding labels of the samples from the previous mini-batches are stored in the queue, with this set denoted as Y_{Q}.

In (5), a rehearsal memory is provided containing exemplars from previous training tasks. In some embodiments, there is a fixed limit of M samples for the memory. Thus, with the arrival of data in new tasks, a portion of the older exemplars may be required to be deleted to make room for representatives corresponding to newly introduced classes. The exemplar set stored in the memory during task t is denoted as [symbol] ₜ.

During the t-th task, the training data comprises newly arrived data and the data from the exemplar memory [symbol] ₜ↔ [symbol] ₜ. Each training mini-batch consists of two sets of N_{b} images, namely x=[x₁, . . . , x_{N}_{_{b}}] and \hat{x}={\hat{x}₁, . . . , \hat{x}_{N}_{_{b}}}. These images are sampled such that xᵢ and \hat{x}ᵢ are from the same class. Thus, a single vector of class labels is defined corresponding to the samples in x and \hat{x} as y=[y, . . . , y_{N}_{_{b}}].

Two random realizations of the augmentation pipeline, namely U˜T and U′˜T in order to create two correlated views of each data sample in x and \hat{x}. These augmented views are then fed to the query and momentum encoders to generate dₚ dimensional feature vectors.

To formulate the supervised contrastive loss, two sets of feature vectors are formed, namely Z₁=[e_{q}(U(x))|eₖ(U′(x))|Q]∈ [symbol] and Z₂=[e_{q}(U(x))|eₖ(U′(\hat{x}))|Q]∈ [symbol] where ⋅|⋅ is the concatenation operation. The label sets corresponding to Z₁ and Z₂ are also given as y₁=y₂=[y|y|Y_{Q}]∈ [symbol] . The contrastive loss function can thus be defined using the following Equation 2:

[symbol]

=λ₁ [symbol] _{SupCon}(Z₁)+λ₂ [symbol] _{SupCon}(Z₂) Equation 2:

Where λ₁ and λ₂ are weight hyper-parameters and [symbol] _{SupCon}(Z₁) is the supervised contrastive loss defined on the feature vector set Z₁ and is given using Equation 3:

$${ℒ}_{SupCon} ( {Z}_{1} ) = \frac{1}{\vert {I}_{1} \vert} {\sum }_{i ∈ {I}_{1}} \frac{- 1}{\vert P ( i ) \vert} {\sum }_{p ∈ P ( i )} log \frac{exp ( {z}_{i} \cdot \frac{{z}_{p}}{τ} )}{{\sum }_{a ∈ A ( i )} exp ( {z}_{i} \cdot \frac{{z}_{a}}{τ} )} \qquad Equation 3$$

Where I₁≡{1, 2, . . . 2N_{b}+Q} is the index set of Z₁, zᵢ=[Z₁]ᵢ is the i-th encoding vector in Z₁, (also known as the anchor in the contrastive loss), ⋅ is the dot product operation and τ is a positive temperature hyper-parameter. Furthermore,

$$A ( i ) = \frac{{I}_{1}}{\{ i \}}$$

and P(i)≡{p∈A(i):[y₁]ᵢ=[y₁]ₚ} is the index set of positives for the i-th anchor. [symbol] _{SupCon}(Z₂) is defined similarly.

In the proposed training framework, the encoding vectors from the current mini-batch are augmented with those from previous batches using Q( [symbol] _{SupCon}(Z₁)). A second component is also added to the loss, that is [symbol] _{SupCon}(Z₂), which uses the encodings of two different samples from the same class (e_{q}(U(x)), eₖ(U′(\hat{x}))) as the minimum required anchor-positive pairs.

At the end of the training step, the FIFO queue is updated by discarding the oldest N_{b} feature vectors and inserting e_{q}(U(x)) and y. The weights of the momentum encoder are also updated according to Equation 1.

### Class Incremental Fine Tuning From Memory

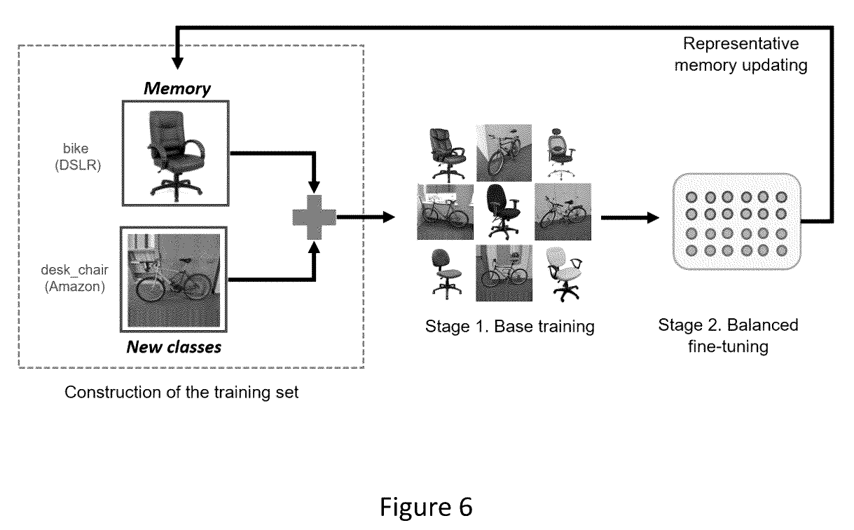

During the second stage of the training for task t, the rehearsal memory is updated by reducing the number of exemplars for classes in previous tasks and populating the empty space in the memory with exemplars from the new tasks. This is shown in FIG. 6. Both exemplars that need to be removed from the memory and those that are to be added to the memory may be selected randomly. The set of images in the rehearsal memory may act as a balanced training set to further fine-tune the weights of the feature extractor in the query encoder (f_{q}). This is done by adding a classification head on top of the base feature extractor, given by: h_{q}(⋅): [symbol] → [symbol] . The classification head may be an MLP with zero or more hidden layers and a softmax output layer. The network, including the base feature extractor and the classification head, is trained using a standard cross entropy loss, given by Equation 3:

$${ℒ}_{balanced} = \frac{1}{M} {\sum }_{( x , y ) ∈ {M}_{t}} C E ( {h}_{q} ( {f}_{q} ( x ) ) , y ) \qquad Equation 4$$

where CE is the cross-entropy loss.

To perform classification, rather than using the output of the softmax layer from the classification head, the nearest-mean-of-exemplars (NME) method is used based on the output of the base feature extractor. In this method, the class label for a given test sample x* is predicted as given by Equation 5:

$${y}^{*} = {arg}_{c = 1} {min}_{c = 1 , … , \vert {{C}^{\tilde{\sim}}}_{t} \vert} ‖ {f}_{q} ( {x}^{*} ) - \frac{1}{{E}_{c}} {\sum }_{x ∈ {E}_{c}} {f}_{q} ( x ) ‖ \qquad Equation 5$$

where E_{c}≡{(x, y)∈ [symbol] ₜ:y=c} is the set of exemplars in the memory from class c.

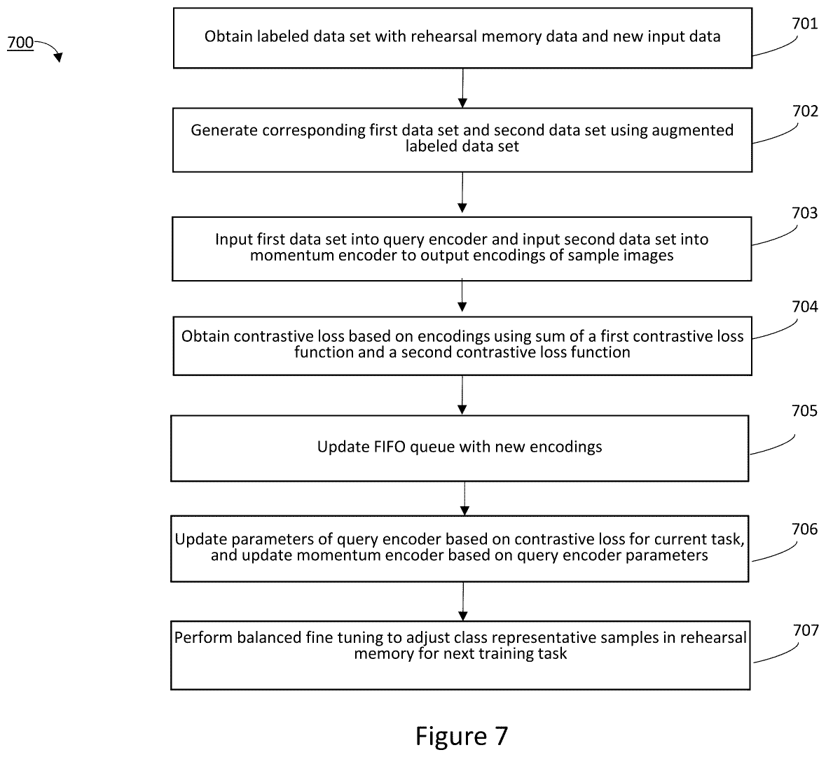

FIG. 7 is a flowchart representation of a method for training a classification model, in accordance with some embodiments. In some implementations, the method 700 is performed by a device with one or more processors and non-transitory memory, such as one of the AI devices 110 shown in FIG. 1 or the AI device 200 shown in FIG. 2. In some embodiments, the method 700 is implemented as a set of computer readable instructions that are executed at a device.

In an embodiment, the method 700 includes obtaining a labeled data set comprising exemplar data stored in a rehearsal memory and newly input data 701, and generating two sets of augmented data 702, e.g., a first set and a second set, where each image in the first set corresponds to an image in the second set. The data may be augmented using any one or more of various augmentation techniques, for example in the case of image data, the images may be flipped, rotated, resized, cropped, grayscale converted, blurred, solarized, or the like.

In some embodiments, the method 700 further includes inputting the first set of augmented data into a query encoder and inputting the second set of augmented data into a momentum encoder, 703. Each of the query encoder and the momentum encoder may include a base feature extractor, such as a convolutional neural network, transformer, or the like, coupled with a projection head, i.e., a multi-layer perceptron with one or more hidden layers. The projection head is used to maximize the similarity between representations of similar examples and minimize the similarity between representations of dissimilar examples.

In some embodiments, the query encoder and the momentum encoder may have the same size, configuration, and may be identical to each other, however other configurations are considered where they are different in size and/or configuration. In some embodiments, the query encoder and momentum encoder may be configured such that the parameters of the momentum encoder are updated at each task using the exponential moving average of the parameters of the query encoder to reflect the global trajectory, i.e., history, of the query encoder. The momentum encoder may represent the global trajectory of the base encoder, thus the parameters of the initial copy of the base encoder at task t=1 may be set to be the parameters of the momentum encoder at task t=0. In this way, the base encoder may incorporate the learning history based on previous tasks. The query encoder and the momentum encoder may output representations, e.g., in the form of feature vectors, corresponding to the input images based on respective trained values of the query encoder and the momentum encoder.

The method 700 may further include obtaining the contrastive loss based on the feature vectors, also referred to as encodings or encoding vectors, using at least one, and in some embodiments, two contrastive loss functions, 704. The contrastive loss may utilize a first-in-first-out (FIFO) queue maintained as a queue of previous data samples. Thus, the encoded keys from the immediate preceding mini-batches may be reused, and the queue decouples the dictionary size from the mini-batch size. The dictionary size may be much larger than a typical mini-batch size, and may be flexibly and independently set as a hyper-parameter. The samples in the dictionary may be progressively replaced, discussed further below, and thus the dictionary represents a sampled subset of all data. The FIFO queue may also be configured to store the corresponding labels from samples from previous mini-batches to enable the supervised aspect of contrastive learning.

A first contrastive loss function may be configured to use encodings of different views of a same input data sample as anchor-positive pairs in the feature space. For example, in the case of an image classifier, this may correspond to samples which are derived from the same image sample as an anchor image, i.e., two samples resulting from different augmentations of the same anchor image. This may ensure at least one anchor-positive pair exists in each mini-batch for contrastive learning.

A second contrastive loss function may be configured to use encodings of two different samples from the same class as the minimum required anchor-positive pairs in the feature space. For example, in the case of an image classifier, this may correspond to two different images having the same label, obtained from the label information of the anchor image. Thus, the samples may be discriminated from each other in a supervised manner and similar images are clustered together using label information.

The contrastive loss may be obtained based on a sum of the first contrastive loss function and the second contrastive loss function. The parameters of the query encoder may be trained using backpropagation based on the obtained contrastive loss. Further, the parameters of the momentum encoder may be updated based on the updated query encoder parameters, representing the exponential moving average of the query encoder parameters.

Embodiments of the method 700 further include updating a first-in-first-out (FIFO) queue with the new mini-batch encodings 705, where the FIFO queue may be configured to store a fixed number of past encoded representations. Updating the FIFO queue with newly obtained feature vectors may also include removing the oldest encoded representations in the FIFO queue to maintain a fixed size of the queue. Some embodiments may use a different criteria for removal of encoded representations from the FIFO queue. In some embodiments, the FIFO queue may also be configured to store the corresponding labels from samples from previous mini-batches to enable the supervised aspect of contrastive learning.

Embodiments may include updating, at 706, the parameters of the query encoder based on the contrastive loss of the current task using back propagation, and updating the parameters of the momentum encoder based on the exponential moving average of the parameters of the query encoder.

In some embodiments, the method 700 may include fine tuning the rehearsal memory 507 for balancing class-incremental training of a classifier between tasks. This may prevent the model from being biased toward the current task. Without fine tuning, training of the model may result in being biased toward the new or most recently learned classes since after training the samples in the rehearsal memory may be imbalanced between old and new classes. Thus, in 707, the rehearsal memory is updated by reducing data from new classes in the rehearsal memory to provide the rehearsal memory with data samples being equally distributed between old and new classes. Both of the images to be removed from the memory and those that are to be added to the memory may be selected randomly. Thus, samples from new classes are sampled to make the number of samples of new classes to be equal to samples of old classes. This may include adding a classification head on top of a base feature extractor in the network, which is trained using a standard cross entropy loss, according to Equation 3, above.

For the training data for the next task, the training data is selected by using the data samples importance in order to maintain the representation quality of the training data. Thus, the rehearsal memory is updated at 707 for the next training data by identifying important samples using their distance between a class wise centroid in the feature space, or samples which have a higher probability in the label space. This is shown and discussed above regarding FIG. 6. Accordingly, between tasks samples are randomly selected from new classes to make the number of new classes equal to the number of old classes. This results in a decrease in the number of samples representing each class in the rehearsal memory as the number of training tasks increases, as representation of the classes is maintained via balanced fine tuning.

### Experimental Results

The above embodiments were tested to evaluate the domain generalized incremental learning method on various benchmarks and existing incremental learning methods. Experiments were performed using the following well-known datasets:

PACS dataset: comprises four distinct domains and is widely used as a domain generalization benchmark. It is composed of four domains (photo, art, cartoon, and sketch), and each domain corresponds to seven categories;

Office-31 dataset: contains 4,100 images of 31 classes, distributed across 3 domains (AMAZON, DSLR, and Webcam);

Office-Home dataset: includes roughly 15,500 images in 65 classes distributed across 4 domains (clipart, product, artistic, and realworld);

DomainNet dataset: composed of six domains, each corresponding to 345 different categories. Since there are about 0.6 million images in this dataset, it represents a large scale benchmark for a multi-source domain generalization and domain adaptation problem. The top 100 classes with the highest number of samples are selected when combined for all domains, which contains a total of about 147,000 training data samples.

Digits-DG dataset: contains samples of 10 digits shared between various datasets including Syn-Digits (synthetic digits), MNIST (Modified National Institute of Standards and Technology), MNIST-M (created by combining MNIST digits with the patches randomly extracted from color photos of Berkeley Segmentation Data Set 500 (BSDS500) as their background), and SVHN (street view house numbers), with domain shift in font style, background, and stroke color. For comparison, MNIST images were scaled to 32×32 treated as RGB, and to ensure that each domain has the same number of training and testing images, each domain was randomly selected with 7,500 images for training and 1,500 test images.

As discussed, the embodiments of the present disclosure addresses the following three incremental learning scenarios for each benchmark:

New Class (NC): the label space is disjointed between training samples from different tasks, but consists of identical set(s) of domains, (see FIG. 3A);

New Domain (ND): training data from different tasks have a shift in domains, but aligned label spaces, (see FIG. 3B);

New Class and New Domain (NCD): training data from different tasks have a domain shift as well as non-overlapping label spaces, (see FIG. 3C).

To formulate NC split, all 100 classes were trained gradually with 10 classes per step for DomainNet, and all 10 classes were trained with 2 classes per step for Digit-DG. For Office-31, the model was trained on 6 classes to start, then the remaining 25 classes were trained with 5 classes per step. For Office-Home, the model was firs trained with 15 classes, then the remaining 50 classes were trained with 10 classes per step. For PACS dataset, the number of new classes at each task were {3, 2, 2}.

To construct NCD split with multi-domain dataset, the label space of the dataset was randomly split by domain. Each class of incoming data from every task contained images from a new domain, and the label space trained in each task were disjoint between tasks. The test accuracy was then calculated on the samples from all classes and domains encountered thus far. Table 1 below describes the NCD split that was considered for the Office-31 dataset.

TABLE 1

Train

| Task id | old | new | Test |
|---|---|---|---|
| 1 | — | D₍₁₋₁₁₎ | D₍₁₋₁₁₎ |
| 2 | D₍₁₋₁₁₎ | A₍₁₂₋₂₁₎ | D, A₍₁₋₂₁₎ |
| 3 | D₍₁₋₁₁₎, A₍₁₂₋₂₁₎ | W₍₂₂₋₃₁₎ | D, A, W₍₁₋₃₁₎ |

In Table 1 above, the implementations of the evaluation protocols for NCD scenario on the Office-31 dataset are shown. The letters D, A, and W denote the samples from domain DSLR (D), Amazon (A), and Webcam (W). The values in parentheses indicate the range of label space to which the data belonged.

For ND split, all incoming data contains only images from the new domain. Thus, the number of incremental tasks performed by the NCD setting is equal to the number of domains in the data set. For PACS, incremental learning with ND and NCD splits were conducted by changing the domain in order of sketch→photo→cartoon→art painting. With Office datasets, a sequence of encountered domains was considered from DSLR to Amazon to Webcam for Office-31, and an ordering of Product→Realworld→Clipart→Art was used for Office-Home. For DomainNet, five different domains were used to build a NCD split as Clipart→Real→Infograph→Sketch→Painting, and Quickdraw was added last in NC split. Finally, for Digits-DG, a domain ordering of SYN→MNIST→MNIST-M→SVHN was used.

For setting the number of new classes at each task for NCD splits, the division of classes belonging to each domain was as balanced as possible, using a split {aᵢ}ᵢ₌₀^{m-1}, where

$${a}_{i} = [ \frac{n}{m} ] , i = 1 , … , m - 1 , and {a}_{0} = [ \frac{n}{m} ] + n mod m$$

for all benchmarks except PACS dataset where {2, 2, 2, 1} was used. In the experiments, all methods used the same order for classes and domains for the same benchmark.

### Evaluation Metric

Two performance metrics were used for evaluation: classifier probabilities-based and nearest-mean-of-exemplars (NME)-based classification, that are conventionally used in most previous incremental learning methods. For each method, the higher accuracy of the two inference results was used as the performance. In the following tables, “# P_{ncd}” represents the final parameters count in NCD scenario, where the value represents millions units.

### Implementation Details

All compared methods were implemented with PyCIL, a known Python toolbox for Class-Incremental Learning, and performance of the methods was reproduced on the benchmark datasets. The standard ResNet-18 was adopted as the feature extractor, except for Digit-DG dataset, which used a modified 32-layer ResNet to prevent overfitting. Images were resized for Office-31, Office-Home, and DomainNet to 112×112 and the images in PACS were resized to 24×24. Digits-DG images were resized to 32×32.

For contrastive learning, the batch size was set to 32, feature update momentum was set to 0.9, and the MLP head used a hidden dimension of 1024. Stochastic gradient descent (SGD) was used as the optimizer, with weight decay of 1e-04 with a cosine annealing schedule and learning rate starting from 0.002. For the momentum teacher network, the temperature was set to τ=0.01 and the coefficient of momentum encoder eₖ is m=0.999. The weights parameter of the loss function λ₁ and λ₁ were set equal to 0.5.

For data augmentations in contrastive learning, the augmentation policy included random resized cropping, horizontal flipping, color jittering, grayscale conversion, blurring, and solarization. Two crops for each image were performed in each iteration.

The model was trained with the fixed memory size of 500 exemplars for Digits-DS and 2,000 exemplars for the other benchmarks. For all compared methods, the training epochs were set to 70 for Digits with batch size 128 and 200 epochs with batch size 256 for other benchmarks. For contrastive learning for the embodiments of the present disclosure, batch size was set to 120 and 40 epochs for training and memory-balanced fine-tuning in every incremental task on Digits dataset, and 600 batch size and 200 epochs for the other datasets. Training was tested for all compared methods with 600 epochs, where performance was the same or worse due to overfitting. For all methods, iCaRL (incremental classifier and representation learning) herding-based step was used for prioritized exemplar selection.

For DyTox (Transformers for Continual Learning with DYnamic TOken eXpansion), a Vision Transformer architecture was used called ConViT, which involves a type of vision transformer that uses a gated positional self-attention module (GPSA), a form of positional self-attention which can be equipped with a “soft” convolutional inductive bias. It was customized to have parameter counts comparable to ResNet-18. The performance of DER was reproduced without pruning technique as it required sensitive hyperparameter search.

### Quantitative Results

Table 2 and Table 3 below summarize the results on the benchmark experiments. With regard to the NCD split, the embodiments of the present disclosure consistently achieved superior performance over the existing methods for all benchmarks by a considerable margin.

TABLE 2

| | PACS | | | | Office-31 | | | | Office-Home | | | |
|---|---|---|---|---|---|---|---|---|---|---|---|---|
| Methods | NC (3t) | ND | NCD | #P_{ncd} | NC (6t) | ND | NCD | #P_{ncd} | NC (6t) | ND | NCD | #P_{ncd} |
| iCaRL [21] | 85.5 | 70.8 | 49.1 | 11.2 | 83.9 | 84.1 | 57.5 | 11.2 | 62.7 | 46.6 | 49.7 | 11.2 |
| BiC [27] | 84.2 | 54.3 | 48.2 | 11.2 | 77.6 | 61.7 | 50.3 | 11.2 | 53.9 | 47.1 | 45.9 | 11.2 |
| PODNet [4] | 88.8 | 74.5 | 55.9 | 11.2 | 81.3 | 79.6 | 55.7 | 11.3 | 57.7 | 57.5 | 47.9 | 11.4 |
| DER w/o P [31] | 92.4 | 72.7 | 44.5 | 44.7 | 81.8 | 82.8 | 53.7 | 33.6 | 66.9 | 58.1 | 48.5 | 44.9 |
| FOSTER [26] | 90.6 | 80.1 | 52.0 | 22.4 | 85.0 | 84.9 | 52.8 | 22.4 | 62.2 | 61.7 | 47.3 | 22.5 |
| DyTox [5] | 82.5 | 45.7 | 48.2 | 11.0 | 78.1 | 62.5 | 57.0 | 11.0 | 46.3 | 45.1 | 38.0 | 11.1 |
| Ours | 94.2 | 86.4 | 62.5 | 23.5 | 92.1 | 92.0 | 67.8 | 23.5 | 61.0 | 56.6 | 53.7 | 23.5 |

Table 2 above shows the average incremental accuracy on the following datasets with three types of continual learning scenarios: PACS (4 domains with 7 classes), Office-31 (3 domains with 31 classes), and Office-Home (7 domains with 65 classes). In the table, ‘t’ denotes the number of tasks and #Pncd represents the final parameters count of the model under the NCD setting. The performance of all existing methods were reproduced and trained using the same class and domain ordering for each benchmark. The number of tasks for ND and NCD is always equal to the number of domains in each dataset.

TABLE 3

| | DomainNet | | | | Digits-DG | | | |
|---|---|---|---|---|---|---|---|---|
| Methods | NC (10t) | ND | NCD (5t) | #P_{ncd} | NC (5t) | ND | NCD | #P_{ncd} |
| iCaRL [21] | 59.5 | 52.4 | 41.8 | 11.2 | 84.5 | 76.1 | 50.4 | 0.46 |
| BiC [27] | 54.3 | 32.2 | 39.0 | 11.2 | 77.5 | 74.9 | 57.5 | 0.46 |
| PODNet [4] | 56.7 | 44.6 | 39.1 | 11.6 | 66.5 | 86.1 | 49.6 | 0.46 |
| Meta-DR^{†} [25] | 46.4 | 48.7 | — | — | 89.2 | 94.0 | — | — |
| DER w/o P [31] | 70.5 | 57.5 | 43.2 | 56.2 | 89.2 | 93.8 | 55.3 | 1.85 |
| DER-EM^{†} [28] | 66.9 | 61.1 | — | — | 91.3 | 97.1 | — | — |
| FOSTER [26] | 64.1 | 59.2 | 44.6 | 22.6 | 85.3 | 91.5 | 54.3 | 0.93 |
| DyTox [5] | 48.4 | 45.9 | 38.0 | 10.9 | 82.9 | 81.3 | 53.8 | 0.68 |
| Ours | 48.5 | 61.1 | 47.2 | 23.6 | 93.6 | 84.6 | 61.3 | 0.94 |

Table 3 above shows the average incremental accuracy on the datasets DomainNet (6 domains with 100 selected classes) and Digits-DG (4 domains with 10 classes). The results for methods denoted with † are taken from “General incremental learning with domain-aware categorical representations,” by Jiangwei Xie, Shipeng Yan, and Xuming He, In Proceedings of the IEEE/CVF Conference on Computer Vision and Pattern Recognition, 2022, (hereinafter “Xie”), and involve configurations which had a different ordering for both domain and class. On DomainNet with NCD split, its reported performance was evaluated for settings that are quite different from the protocol discussed herein, so direct comparison was not available.

The embodiments of the present disclosure improves the average top-1 accuracy by 10.3% for Office-31, 6.6% for PACS, and 4% for Office-Home, and improved by 3.8% and 2.6% for Digits-DG and DomainNet datasets, respectively. The results establish that the embodiments of the present disclosure are more effective at mitigating catastrophic forgetting as well as domain generalization which was not considered in the previous class incremental learning methods.

Considering that data corresponding to multiple domains are trained together in the same label space in NC split, the performance of each task in NC split can be regarded as the accuracy for multi-domain classification. The embodiments of the present disclosure also shows higher performance on this setting than other methods for all datasets, with the exception of Office-Home and DomainNet in some cases.

For DomainNet and Digit-DG datasets, the experiments also included comparison of the reported performance of Meta-DR and DER-EM provided by Xie, which targets the problem of domain shift between incremental tasks. However, a direct comparison was not available with the results discussed in Xie for NCD split, because they gradually decrease the number of new incoming categories of incremental tasks exceeding the number of domains, which is quite different than the protocol disclosed herein for the NCD scenario. For the ND split, the embodiments of the present disclosure maintain better or comparable performance on DomainNet, while DER-EM may be found to perform better than other baselines on the Digit-DG dataset.

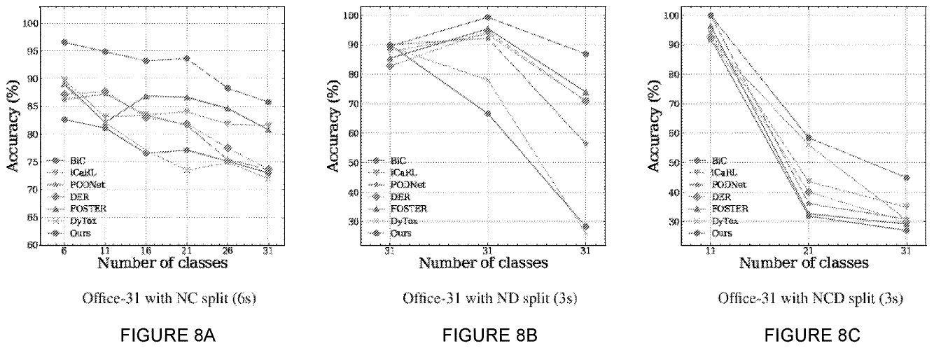

Referring now to FIG. 8, depicted are the performance changes as each task progresses in number of classes on the Office-31 dataset, according to the NC split (FIG. 8A), ND split (FIG. 8B), and NCD split (FIG. 8C). It can be seen that the embodiments of the present disclosure (indicated by “Ours”) has the best learning performance in accuracy for a single domain as well as a dataset in which multiple domains are mixed at once. Since the embodiments of the present disclosure only trains a base network and updates a momentum encoder without any structural expansion, the total number of parameter counts are fixed at twice that of the base network in incremental tasks while training.

### Ablation Study Experiment Results

### Balanced Fine-Tuning

Table 4 below shows a comparison of the impact of the balanced fine-tuning step between each tasks, where data from new classes is reduced to have equally distributed batches between old and new classes, (see FIG. 6). Applying balanced fine-tuning improves performance for all types of splits as it prevents the model from being biased toward the current task, which is effective in alleviating task imbalances during training. As show in the results in Table 4 below, removing the balanced fine-tuning step (Bft set to X) results in markedly worse results in terms of accuracy and forgetting as compared to when balanced fine-tuning step is included (Bft check mark), for each of NC, NCD, and NCD scenarios.

TABLE 4

| | |
|---|---|
| Incremental | top-1 accuracy (%) |

| scenario | Bft | Avg (↑) | Last (↑) | Forgetting (↓) |
|---|---|---|---|---|
| NC | [symbol] | 86.84 | 82.88 | 4.33 |
| | ✓ | 92.06_{+5.22} | 85.82_{+2.94} | 3.75_{0.58} ↓ |
| ND | [symbol] | 89.50 | 81.79 | — |
| | ✓ | 91.95_{+2.45} | 86.91_{+5.12} | — |
| NCD | [symbol] | 66.55 | 37.50 | 41.51 |
| | ✓ | 67.79_{+1.24} | 44.91_{+7.41} | 29.47_{12.04} ↓ |

### Different Components of Contrastive Loss

Table 5 below shows the results of ablation of different components of the contrastive loss in the embodiments of the present disclosure. The performance of the embodiments when optimizing with only one of the loss components of the two different contrastive loss variants [symbol] _{SupCon}(Z₁), λ₂ [symbol] _{SupCon}(Z₂) is shown. This was done by adjusting the values of the hyper parameters λ₁ and λ₂. To compare more specific performance, three standard metrics were measured in the continual learning literature: average accuracy which measures the overall performance of test sets after each step (Avg), top-1 accuracy, and the final top-1 accuracy after the last step (Last), as compared on the Office-31 dataset for the NCD scenario. Also, an average forgetting (Forgetting) is included as an additional metric that measures how much the model forgot about the task given its current state.

For a classification problem, let a_{k,j} be the performance of the model on the held-out test set of the j-th task (k≤k) after the model is trained incrementally from task 1 to i. When fⱼ^{k} quantify how much the model forgets for the j-th task after being trained on task k>j, the average forgetting as k-th task is

$${F}_{k} = \frac{1}{k - 1} {\sum }_{j = 1}^{k - 1} {f}_{j}^{k} ,$$

where fⱼ^{k}= [symbol] _{{1, . . . , k-1}} [symbol] _{,j}−a_{k,j}.

TABLE 5

| | | top-1 accuracy (%) | | |
|---|---|---|---|---|
| [symbol] _{SC}(Z₁) | [symbol] _{SC}(Z₂) | Avg (↑) | Last (↑) | Forgetting (↓) |
| [symbol] | ✓ | 64.62 | 32.34 | 41.09 |
| ✓ | [symbol] | 67.43 | 34.24 | 45.02 |
| ✓ | ✓ | 67.79 | 44.91 | 29.47 |

With the results in Table 5, it is noted that without [symbol] _{SupCon}(Z₁) there is significant degradation in both average and last classification accuracy. In addition, it is noted that forgetting becomes very severe when there is no loss of either one. Optimizing both properties improves overall performance for continual learning, confirming the effect of each loss on continual learning for representation.

Accordingly, the embodiments disclosed herein include solutions to the incremental learning problem for deep-learning based classifiers, including image classifiers. In particular, disclosed are embodiments of a class-incremental learning under covariate shift, in which the label set of the data expands while its underlying distribution changes over time. The disclosed embodiments include domain generalized incremental learning (DGIL) to realize improved performance for deep learning models in a constantly changing deployment environment. By employing domain generalization via contrastive learning and momentum distillation, the disclosed embodiments may maintain performance stability as the distribution of the data shifts between different domains. Plasticity of the model may be achieved through balanced fine-tuning using a rehearsal memory of exemplars, populated throughout the learning time horizon.

As discussed, the disclosed embodiments show marked improvements in performance as compared to existing approaches in the prior art, particularly in challenging scenarios where the model continually learns to identify new classes under covariate shift (NCD).

Implementations according to the present disclosure described above may be implemented in the form of computer programs that may be executed through various components on a computer, and such computer programs may be recorded in a computer-readable medium. Examples of the computer-readable media include, but are not limited to: magnetic media such as hard disks, floppy disks, and magnetic tape; optical media such as CD-ROM disks and DVD-ROM disks; magneto-optical media such as floptical disks; and hardware devices that are specially configured to store and execute program codes, such as ROM, RAM, and flash memory devices.

Meanwhile, the computer programs may be those specially designed and constructed for the purposes of the present disclosure or they may be of the kind well known and available to those skilled in the computer software arts. Examples of program code include both machine codes, such as produced by a compiler, and higher level code that may be executed by the computer using an interpreter.

As used in the present disclosure (especially in the appended claims), the singular forms “a,” “an,” and “the” include both singular and plural references, unless the context clearly states otherwise. Also, it should be understood that any numerical range recited herein is intended to include all sub-ranges subsumed therein (unless expressly indicated otherwise) and accordingly, the disclosed numeral ranges include every individual value between the minimum and maximum values of the numeral ranges.

Operations constituting the method of the present disclosure may be performed in appropriate order unless explicitly described in terms of order or described to the contrary. The present disclosure is not necessarily limited to the order of operations given in the description. All examples described herein or the terms indicative thereof (“for example,” etc.) used herein are merely to describe the present disclosure in greater detail. Therefore, it should be understood that the scope of the present disclosure is not limited to the example implementations described above or by the use of such terms unless limited by the appended claims. Therefore, it should be understood that the scope of the present disclosure is not limited to the example implementations described above or by the use of such terms unless limited by the appended claims. Also, it should be apparent to those skilled in the art that various alterations, substitutions, and modifications may be made within the scope of the appended claims or equivalents thereof.

Therefore, technical ideas of the present disclosure are not limited to the above-mentioned implementations, and it is intended that not only the appended claims, but also all changes equivalent to claims, should be considered to fall within the scope of the present disclosure.

What is claimed is:

1. A computer-implemented method for training a classification model, the computer-implemented method comprising:
obtaining a labeled data set of images comprising data from a rehearsal memory and new input data;
augmenting the labeled data set to generate a first data set and a second data set, wherein each image of the first data set corresponds to a corresponding image of the second data set;
inputting the first data set into a query encoder and inputting the second data set into a momentum encoder to obtain encodings output by the query encoder and the momentum encoder;
obtaining a contrastive loss based on the encodings using a sum of a first contrastive loss function and a second contrastive loss function;
updating parameters of the query encoder based on the obtained contrastive loss; and
updating parameters of the momentum encoder based on parameters of the query encoder.

2. The method of claim 1, further comprising updating the rehearsal memory with samples of the new input data.

3. The method of claim 2, wherein the rehearsal memory is updated based on a balanced-fine tuning such that a number of samples of data existing in the rehearsal memory from previous tasks is equal to a number of samples of the new input data to be stored in the rehearsal memory.

4. The method of claim 3, wherein images of the samples of data existing in the rehearsal memory from previous tasks and images of the samples of the new input data to be stored in the rehearsal memory are both selected randomly.

5. The method of claim 1, wherein the query encoder and the momentum encoder have a same size and configuration.

6. The method of claim 1, wherein the first contrastive loss function is configured to identify encodings of different views of a same input image as anchor-positive pairs in a feature space.

7. The method of claim 6, wherein the second contrastive loss function is configured to identify encodings of two different sample images from a same class as anchor-positive pairs in the feature space.

8. The method of claim 1, wherein parameters of the momentum encoder are updated based on exponentially weighted moving averages of the parameters of the query encoder.

9. A non-transitory memory storing one or more programs, which, when executed by the one or more processors of a computing device, cause the computing device to perform:
obtaining a labeled data set of images comprising data from a rehearsal memory and new input data;
augmenting the labeled data set to generate a first data set and a second data set, wherein each image of the first data set corresponds to a corresponding image of the second data set;
inputting the first data set into a query encoder and inputting the second data set into a momentum encoder to obtain encodings output by the query encoder and the momentum encoder;
obtaining a contrastive loss based on the encodings using a sum of a first contrastive loss function and a second contrastive loss function;
updating parameters of the query encoder based on the obtained contrastive loss; and
updating parameters of the momentum encoder based on parameters of the query encoder.

10. The non-transitory memory of claim 9, wherein the stored one or more programs further cause the computing device to perform:
updating the rehearsal memory with samples of the new input data.

11. The non-transitory memory of claim 9, wherein the rehearsal memory is updated based on a balanced-fine tuning such that a number of samples of data existing in the rehearsal memory from previous tasks is equal to a number of samples of the new input data to be stored in the rehearsal memory.

12. The non-transitory memory of claim 11, wherein, images of the samples of data existing in the rehearsal memory from previous tasks and images of the samples of the new input data to be stored in the rehearsal memory are both selected randomly.

13. The non-transitory memory of claim 9, wherein the query encoder and the momentum encoder have a same size and configuration.

14. The non-transitory memory of claim 9, wherein the first contrastive loss function is configured to identify encodings of different views of a same input image as anchor-positive pairs in a feature space.

15. The non-transitory memory of claim 14, wherein the second contrastive loss function is configured to identify encodings of two different sample images from a same class as anchor-positive pairs in the feature space.

16. The non-transitory memory of claim 9, wherein parameters of the momentum encoder are updated based on exponentially weighted moving averages of the parameters of the query encoder.

17. A computing device for training a classification model to be provided to an edge device, the computing device comprising:
a transceiver;
a memory; and
one or more processors configured to:
obtain a labeled data set of images comprising data from a rehearsal memory stored in the memory and new input data;
augment the labeled data set to generate a first data set and a second data set, wherein each image of the first data set corresponds to a corresponding image of the second data set;
input the first data set into a query encoder and inputting the second data set into a momentum encoder to obtain encodings output by the query encoder and the momentum encoder;
obtain a contrastive loss based on the encodings using a sum of a first contrastive loss function and a second contrastive loss function;
update parameters of the query encoder based on the obtained contrastive loss;
update parameters of the momentum encoder based on parameters of the query encoder; and
provide the classification model including parameters of the query encoder to the edge device via the transceiver.

18. The device of claim 17, wherein the one or more processors are further configured to update the rehearsal memory with samples of the new input data.

19. The device of claim 18, wherein the rehearsal memory is updated based on a balanced-fine tuning such that a number of samples of data existing in the rehearsal memory from previous tasks is equal to a number of samples of the new input data to be stored in the rehearsal memory.

20. The device of claim 17, wherein the first contrastive loss function is configured to identify encodings of different views of a same input image as anchor-positive pairs in a feature space, and
wherein the second contrastive loss function is configured to identify encodings of two different sample images from a same class as anchor-positive pairs in the feature space.
